(19) United States
(12) Patent Application Publication
(10) Pub. No.: US 2020/0278943 A1
(43) Pub. Date: Sep. 3, 2020

(54) IO-LINK MASTER, INTERFACE AND METHODS FOR CONTROLLING AND MONITORING AN IO-LINK SYSTEM

(71) Applicant: Balluff GmbH, Neuhausen a.d.F (DE)

(72) Inventors: Roland Schäfer, Rottweil (DE); Pascal Gaggero, Sutz (CH); Stephan Langer, Neuhausen (DE); Roman Vracko, Stuttgart (DE)

(73) Assignee: Balluff GmbH

(21) Appl. No.: 16/785,804

(22) Filed: Feb. 10, 2020

(30) Foreign Application Priority Data
Feb. 28, 2019 (DE) 102019105171.1

(51) Int. Cl. G06F 13/40

(52) U.S. Cl. CPC G06F 13/4068

(57) ABSTRACT

An interface (10) for an IO-Link master (20) has an IO-Link port transceiver, at least one wireless transceiver and a signal processing apparatus which is configured to provide a network between the IO-Link port transceiver and the at least one wireless transceiver. In a method for controlling an IO-Link system, a communication partner (30) communicates with at least one IO-Link device (40) via an interface (10). In a method for monitoring the IO-Link system, a communication flow between IO-Link ports (21, 22) of the IO-Link master (20) is stored in a storage element by means of the interface which is connected to the IO-Link master (20). The IO-Link master (20) has at least one IO-Link port (21) which is configured to be connected with an IO-Link port transceiver of the interfaces (10).

The present invention relates to an IO-Link master and an interface for the IO-Link master. The present invention also relates to methods for controlling and monitoring an IO-Link system.

### PRIOR ART

In mechanical and plant engineering as well as in automation technology, numerous standardised field bus systems have proved themselves as an alternative to parallel individual cabling. Here, a plurality of so-called field bus modules is connected to a central control device via the field bus. In turn, terminals are connected to the field bus modules.

More recently, to connect the terminals to the field bus modules, so-called “IO-Link” connections have been used. Such an IO-Link as well as a method and a control device for operating such an IO-Link is known from DE 10 2012 009 494 A1. As described therein, the field bus modules take over the role of an IO-Link master. Sensors, actuators, display devices, operating devices, and even smaller machine drivers are for example considered as terminals (“IO-Link devices” in the following).

A standard for an intelligent sensor/actuator interface with the description “IO-Link” shall be standardised as an international open standard in the standard IEC 61131-9. IO-Link devices are then described via description files IODD (IO-Link Device Description). The IODD should additionally be standardised as a specification language as an open standard in the standard ISO 15745. An IO-Link wireless master with a field bus interface is already described in the existing specification “IO-Link Wireless System Extension”.

An IO-Link provides a serial point-to-point connection for the signal transmission between sensors and actuators and the IO-level of the machine. In principle, an IO-Link transmits data between a defined IO-Link master and a connected IO-Link device as a slave. Field bus modules as well as PLC interface assemblies are available as IO-Link masters.

Conventional field buses are for example PROFIBUS-DP, Interbus, DeviceNet, CC-Link, CC-Link IE Field, CC-Link IE Field Basic, Modbus TCP, Sercos III and CANopen. In addition, field bus standards based on Ethernet such as PROFINET, EtherNet/IP, Ether-CAT, Mechatrolink, Varan, as well as Ethernet POWERLINK are used. Field buses are particularly advantageous when bridging large distances between individual members which can range from several 100 metres up to over 10 km in some cases. It is, however, problematic and disadvantageous that these efficient bus systems cannot be practically economically integrated on the sensor/actuator level.

The parametrisation of IO-Link devices can occur individually on-site by means of screwdrivers on a power potentiometer or via a key press. Alternatively, it is also possible to configure and monitor said devices via the field bus. In this way, access to the field bus usually occurs via the PLC (programmable logic controller).

It is a problem of the present invention to provide a possibility with which to parametrise and monitor IO-Link devices in a simple manner.

### DISCLOSURE OF THE INVENTION

This problem is solved in one aspect of the invention by an interface or a gateway for an IO-Link master. This interface has an IO-Link port transceiver which is configured to establish a connection between the interface and an IO-Link master via an IO-Link Port. The IO-Link port transceiver can be configured, for example, in different embodiments of the interface, in order to insert said IO-Link port transceiver directly into an IO-Link port, or in order to connect said IO-Link port transceiver with said IO-Link port via a cable. Additionally, the interface has at least one wireless transceiver. This can be configured to communicate wirelessly by means of a one or more different radio protocols such as for example Bluetooth. A signal processing apparatus is configured to provide a network between the IO-Link port transceiver and the at least one wireless transceiver, thus facilitating a data exchange between these two elements.

The interface facilitates retrofitting of an existing IO-Link master with an additional means of communication, and in this way facilitating the configuration and monitoring of IO-Link devices. Since the wireless transceiver does not become an integral component of the IO-Link master, it is not necessary to radio certify it.

It is preferred that the interface further has a switching element which is configured to establish a communication connection between a communication partner and the wireless transceiver. In order to ensure that only authorised communication partners can establish a communication connection, it can for example be provided that, by operating the switching element, a setup signal is initially sent to the IO-Link master. This then shows a code on a display in order to ensure that only persons with physical access can connect with the IO-Link master. The code must then be sent from the communication partner to the interface. Only when a comparison in the signal processing apparatus reveals that the correct code has been sent back from the communication partner is the communication connection established.

It is further preferred that the interface has a switching element which is configured to block the establishment of communication connections between a communication partner and the wireless transceiver. As soon as a communication connection is established with a communication partner, by operating this switching element, the establishment of further communication connections with further communication partners can be prevented. In this way, external access to the IO-Link master can be prevented.

It is further preferred that the interface has a switching element which is configured to block communication between the wireless transceiver via at least one predeterminable communication protocol. For example, only the communication via the Bluetooth protocol can hereby be blocked. This embodiment of the interface is particularly useful when it has several wireless transceivers which are each configured for different communication protocols. The switching element can then specifically disable one of the wireless transceivers.

If the interface is meant to facilitate communication via several different wireless communication protocols, it is, in principle, possible that several separate wireless transceivers are provided for this purpose, and also possible that a wireless transceiver is provided which can switch between two different communication protocols at the interface, either automatically or manually, for example by operating a further switching element. In particular, one of the communication protocols used can also be the IO-Link wireless protocol. In this case, the interface is an IO-Link wireless master or an IO-Link wireless device. This or these can have in particular several tracks (transceiver radio), one of which is configured in particular to switch between the IO-Link wireless protocol and a faster protocol, such as for example the Bluetooth protocol.

An antenna of the wireless receiver can be implemented in particular as an external antenna or within a housing of the interface as a chip or as a PBC antenna (PBC=Printed Circuit Board).

The signal processing apparatus is in particular a microcontroller which can provide the network in, for example, the form of an ad-hoc communication protocol.

The communication partner can for example be a mobile terminal, such as for example a smartphone or a tablet PC, as well as a cloud.

It is further preferred that the interface comprises at least one storage element. The signal processing apparatus is configured in this embodiment of the invention to store the data received by the IO-Link port transceiver in the storage device. The storage element can for example be a memory card. This enables the communication flow between all ports of an IO-Link master to be secured in the storage element. This data can then, for example, be analysed offline in a computer.

In a further aspect of the invention, the object is solved by an IO-Link master which has several IO-Link ports. One of the IO-Link ports is configured to be connected with an IO-Link port transceiver of an interface according to one of the aspects of the invention described above. This IO-Link port can therefore function as a service port in order to allow a service employee direct access to the IO-Link master.

Setting up the connection of the IO-Link port with the IO-Link transceiver can preferably take place by the IO-Link master having a signal processing device which is configured to establish a network between the interface and the IO-Link master, which are connected to further IO-Link ports of the IO-Link master. This allows these IO-Link devices to be parametrised and for the data delivered by it, such as for example conditional monitoring data, to be read.

In another further aspect of the invention, the object is solved by a method for controlling an IO-Link system. In this method, a communication partner communicates with at least one IO-Link device via the interface. It is therefore not necessary in this method to communicate with the IO-Link device in situ or to contact said IO-Link device by means of the PLC.

In one embodiment of the method, the IO-Link device is connected to the same IO-Link master as the interface. The communication between the IO-Link device and the interface therefore only occurs via the IO-Link master.

In another embodiment of the method, the IO-Link device is connected to an IO-Link master, which is connected to the IO-Link master to which the interface is connected, via a field bus. In this embodiment, the communication occurs via both IO-Link masters and the field bus. In this way it is possible to also address IO-Link devices which are further away by means of the interface.

In yet another embodiment of the method, the IO-Link master is connected to an IO-Link master which is connected with the IO-Link master to which the interface is connected via a wireless network. Here, further connection elements can be additionally provided. In this way the IO-Link device can, for example, be connected to a first IO-Link master which is connected with a second IO-Link master via a field bus. This can be connected via the wireless network with the third IO-Link master, which is in turn connected with a fourth IO-Link master to which the interface is connected, via a field bus.

In the method, the communication partner can in particular read data of the IO-Link device. If the IO-Link device is, for example, a sensor and the communication partner is a mobile terminal, a service employee can visualise sensor data on the mobile terminal by means of the method.

Furthermore, by means of the method, the communication partner can parametrise in particular the IO-Link device. If the communication partner is a mobile terminal, said mobile terminal offers a user-friendly possibility for parametrising IO-Link devices, without having to manipulate these physically or by means of a screwdriver, or without having to parametrise them via the PLC.

If an IO-Link master has a web interface, an API (application programming interface) or a GUI (graphical user interface), it is then preferred in the method that the communication partner communicates with the interface of the IO-Link master. This can be the IO-Link master to which the interface is connected, or even an IO-Link master which is connected to the IO-link master to which the interface is connected, via a field bus and/or a wireless network. In this way, web access for the communication partner is enabled via the interface.

It is further preferred that the communication between the interface and the IO-Link master does not occur by means of an IO-Link protocol. Instead, it is preferred that the IO-Link master recognises when a communication with the interface via the IO-Link service port should occur and switches to a faster communication protocol for this purpose.

In addition, it is preferred that a transceiver of the interface is switched from an IO-Link wireless protocol to another protocol, in particular to a Bluetooth protocol, in order to communicate with the communication partner.

Finally, the object is solved by a method for monitoring an IO-Link system, in which a communication flow between IO-Link ports of an IO-Link master is stored in a storage element of the interface by means of an interface which is connected to the IO-Link master. This allows the communication flow to be protocolled in the IO-Link system.

It is preferred here that an information flow between IO-Link ports is also additionally stored in the storage element, whose IO-Link master is connected with the IO-Link master to which the interface is connected via a field bus and/or via a wireless network.

### BRIEF DESCRIPTION OF THE DRAWINGS

Exemplary embodiments of the invention are represented in drawings and are further described in the description which follows.

FIG. 1 schematically shows an interface according to an exemplary embodiment of the invention.

FIG. 2 schematically shows how, in an exemplary embodiment of the invention, an IO-Link device communicates with a communication partner via an IO-Link master and an interface.

FIG. 3 schematically shows the communication in an IO-Link system by means of an interface according to an exemplary embodiment of the invention.

FIG. 4 schematically shows the communication in IO-Link systems by means of interfaces according to an exemplary embodiment of the invention.

FIG. 5 schematically shows an interface according to another exemplary embodiment of the invention.

### EXEMPLARY EMBODIMENTS OF THE INVENTION

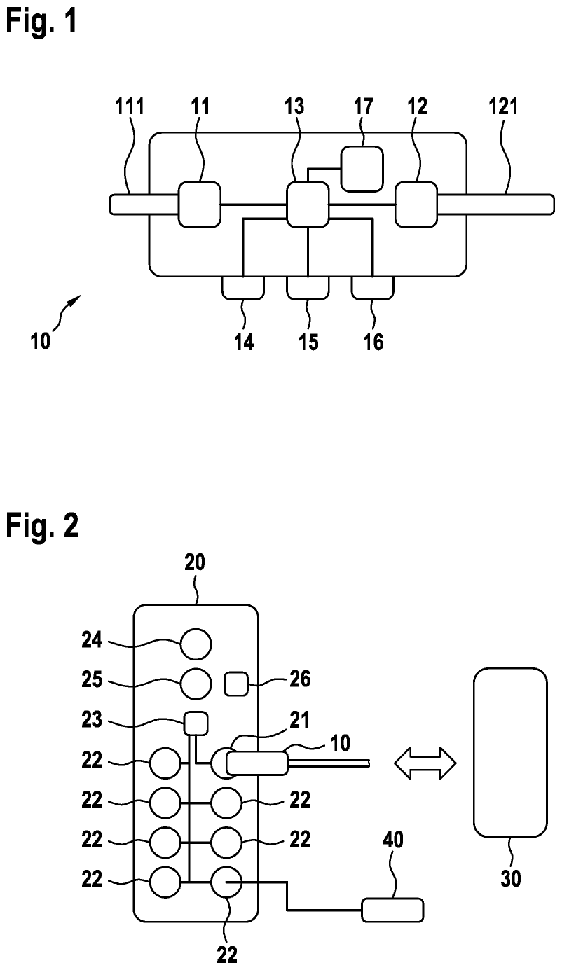

An interface 10 for an IO-Link master according to an exemplary embodiment of the invention is depicted in FIG. 1. It has an IO-Link port transceiver 11 which is configured as an IO-Link wired transceiver. This is connected with an IO-Link wired connector 111 in the form of a plug for an IO-Link port. Additionally, the interface 10 has a wireless transceiver 12 which is configured as a Bluetooth transceiver and has an antenna 121. A signal processing apparatus 13 in the form of a microcontroller is connected with the IO-Link port transceiver 11 and with the wireless transceiver 12 and establishes a network between these two. It is additionally connected with three switching elements 14, 15, 16 in the form of pressure switchers. The first switching element 14 is a pairing pressure button, by whose actuation a pairing signal can be sent by means of the IO-Link port transceiver 11 to an IO-Link master. The second switching element 15 is configured to block the establishment of further communication connections via the wireless transceiver as well as pre-existing communication connections. The third switching element 16 is configured to block connections by means of the wireless transceiver 12 via the Bluetooth protocol. In addition, a storage element 17 in the form of a memory card is provided. The signal processing apparatus 13 is configured to read the communication, via the IO-Link port transceiver 11, between IO-Link ports of an IO-Link master to which the interface 10 is connected. The entire communication is stored by the signal processing apparatus 13 on the storage element 17. This can be removed from the interface 10 in order to feed the data saved thereon to a computer, on which the data can then be analysed.

As depicted in FIG. 2, the interface 10 can be directly inserted into an IO-Link port 21 of an IO-Link master by means of the IO-Link wired connector 111. It can for example be secured to the IO-Link port 21 by means of a screw connection not depicted. This IO-Link port 21 is described in the following as an IO-Link service port. Further IO-Link ports 22 of the IO-Link master are connected to the IO-Link service port 21 via a signal processing apparatus 23 within the IO-Link master in such a way that the interface 10 can exchange data with an IO-Link device 40 connected to an IO-Link port 22. Said data can be transmitted to a communication partner 30 in the form of a smart phone. The IO-Link master 20 additionally has a field bus communication interface 24, an electrical power supply 25, a display 26 and a web interface. The web interface facilitates a web communication via the field bus communication interface 24 or, according to the invention, via the interface 10. When a pairing signal is sent to the signal processing apparatus 23 via the IO-Link service port 21, a code stored therein is shown on the display 26. The user of the communication partner 30 must then read said code and enter it into the communication partner 30. Said communication partner in turn sends it back via the interface 10 to the IO-Link master and to its signal processing apparatus 25. Only when it is recognised in the signal processing apparatus 25 that the correct code has been entered is access to the other IO-Link ports 22 and the IO-Link device 40 granted to the interface 10. Access to further IO-Link masters which are connected via the field bus communication interface 24 to this IO-Link master 20 is also now granted. Similarly, access to the web interface is facilitated.

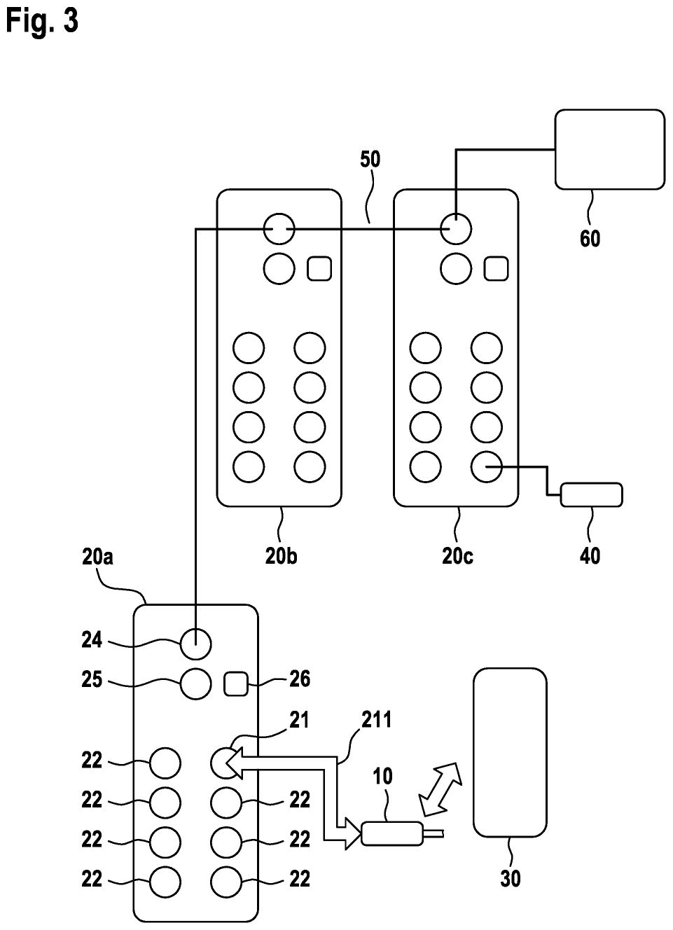

As depicted in FIG. 3, the interface 10 does not have to be inserted directly to the IO-Link service port 21. Instead, the IO-Link wired connector 111 can also be connected to the IO-Link service port 21 via a cable 211. This allows the interface to be positioned at a larger distance to an IO-Link master 20a, which facilitates simpler access by means of the communication partner 30. If further IO-Link masters 20b, 20c and a PLC 60 are connected with the first IO-Link master 20a by means of a field bus 50, the communication partner 30 can also access these. In particular, this also facilitates the reading of data of an IO-Link device 40 which is connected to an IO-Link master 20c further away. Parameterising this IO-Link device 40 is also possible without there being direct physical access to it.

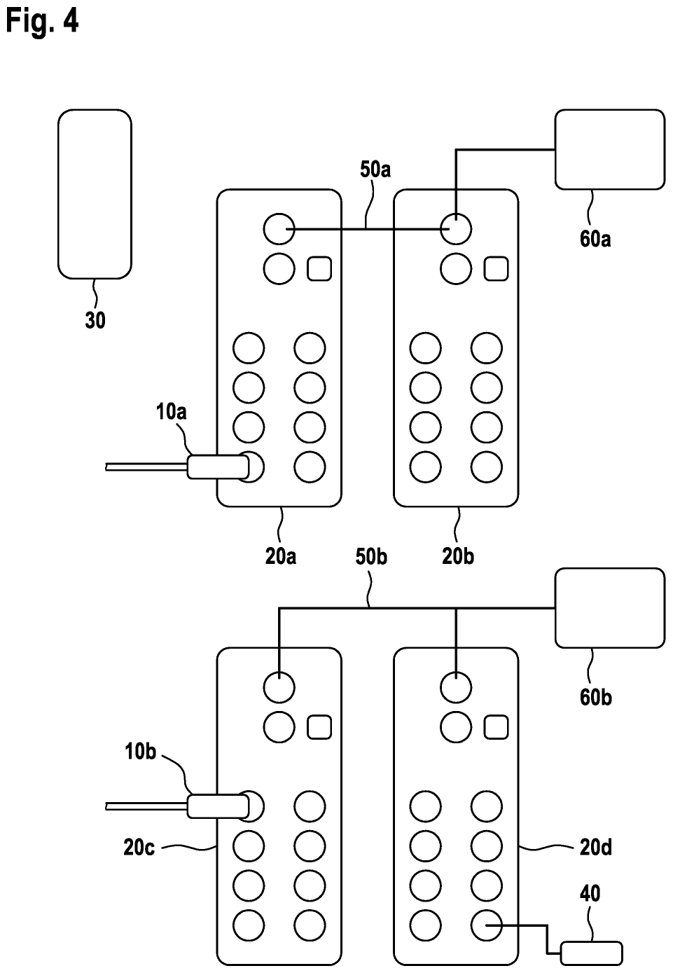

FIG. 4 shows an exemplary embodiment in which, in a first IO-Link system, an interface 10a is connected to a first IO-Link master 20a. This is connected via a first field bus 50a with a second IO-Link master 20b and a first PLC 60a. A second IO-Link system has a second interface 10b which is connected to a third IO-Link master 20c. Via a second field bus 50b, a fourth IO-Link master 20d and a second PLC 60b are connected to the third IO-Link master 20c. An IO-Link device 40 is connected to the fourth IO-Link master 20d. The IO-Link masters 20a to 20d of both IO-Link systems are connected with one another via a wireless mesh network. If the user of a smartphone which functions as a communication partner 30 only finds themselves within the reach of the second interface 10b, they can still access the IO-Link device 40 which is far away, the wireless network and the field buses 50a, 50b via the first interface 10a.

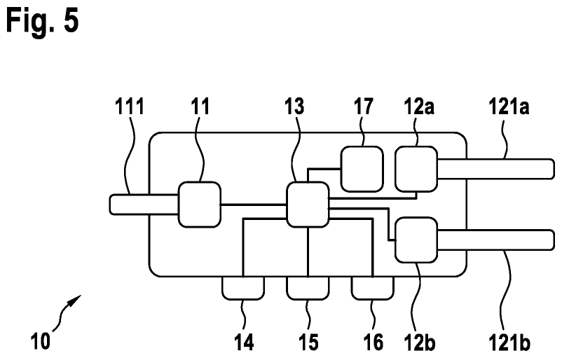

FIG. 5 shows a further embodiment of an interface 10 which has all the components of the interface 10 according to FIG. 1. Instead of only one wireless transceiver 12 having an antenna 121, this interface 10 has, however, two wireless transceivers 12a, 12b, each having one antenna 121a, 121b respectively. This interface 10 is configured as an IO-Link wireless master. Here, the first wireless transceiver 12a communicates via the IO-Link wireless protocol, whereas the second transceiver 12b automatically changes according to need and configuration between the IO-Link wireless protocol and the Bluetooth protocol and is configured for communicating with the communication partner 30.

1. An Interface for an IO-Link master, comprising:
an IO-Link port transceiver,
at least one wireless transceiver, and
a signal processing apparatus which is configured to provide a network between the IO-Link port transceiver and the at least one wireless transceiver.

2. The Interface according to claim 1, further comprising a switching element which is configured to establish a communication connection between a communication partner and the wireless transceiver.

3. The Interface according to claim 1, further comprising a switching element which is configured to block the establishment of communication connections between a communication partner and the wireless transceiver.

4. The Interface according to claim 1, further comprising a switching element which is configured to block a communication with the wireless transceiver via at least one predeterminable communication protocol.

5. The Interface according to claim 1, further wherein the interface is an IO-Link wireless master or an IO-Link wireless device.

6. The Interface according to claim 1, further comprising several wireless transceivers.

7. The Interface according to claim 1, further comprising at least one storage element, wherein the signal processing apparatus is configured to store data received by the IO-Link port transceiver in the storage element.

8. The Interface according to claim 1, further comprising at least one IO-Link port which is configured to be connected with an IO-Link port transceiver.

9. The Interface according to claim 8, further wherein the IO-Link master has a signal processing device which is configured to provide a network between the interface and IO-Link devices which are connected to further IO-Link ports of the IO-Link master.

10. The Interface of claim 1, further comprising an IO-Link system in which a communication partner communicates with at least one IO-Link device via an interface.

11. The Interface according to claim 8, further wherein the IO-Link device is connected to the same IO-Link master as the interface.

12. The Interface according to claim 8, further wherein the IO-Link device is connected to an IO-Link master which is connected with the IO-Link master to which the interface is connected, via a field bus.

13. The Interface according to claim 8, further wherein the IO-Link device is connected to an IO-Link master, which is connected with the IO-Link master to which the interface is connected, via a wireless network.

14. The Interface according to claim 10, further wherein the communication partner reads data of the IO-Link device.

15. The Interface according to claim 10, further wherein the communication partner parametrises the IO-Link device.

16. The Interface according to claim 10, further wherein the communication partner further communicates with a web interface, an API or a GUI of an IO-Link master, to which the interface is connected or which is connected via a field bus or a wireless network with the IO-Link master to which the interface is connected.

17. The Interface according claim 8, further wherein the communication between the interface and the IO-Link master does not occur by means of an IO-Link protocol.

18. The Interface according to claim 8, further wherein a transceiver of the interface is switched from an IO-Link wireless protocol to another protocol in order to communicate with the communication partner.

19. The Interface of claim 7, further wherein a communication flow between IO-Link ports of an IO-Link master is stored in a storage element by means of an interface which is connected to the IO-Link master.

20. The Interface according to claim 19, further wherein an information flow between IO-Link ports is further stored in the storage element, whose IO-Link master is connected with the IO-Link master to which the interface is connected, via a field bus or a wireless network.
